(19) United States
(12) Patent Application Publication
(10) Pub. No.: US 2008/0319985 A1
(43) Pub. Date: Dec. 25, 2008

(54) STORAGE MEDIUM, DATA EXTRACTION APPARATUS AND METHOD

(75) Inventors: Masataka Matsuura, Kawasaki (JP); Hiroya Hayashi, Kawasaki (JP); Masahiko Nagata, Kawasaki (JP); Kiyohide Omiya, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/131,630

(22) Filed: Jun. 2, 2008

Related U.S. Application Data
(63) Continuation of application No. PCT/JP2005/022699, filed on Dec. 9, 2005.

(51) Int. Cl. G06F 7/06; G06F 17/30

(52) U.S. Cl. 707/5; 707/E17.014

(57) ABSTRACT

One or more extraction conditions for designating data to be extracted can be input in a program. When one or mode extraction conditions are input, a data extraction is carried out for each of the extraction conditions and the extracted data is output to an output destination in accordance with the extraction condition that the present data satisfies.

### CROSS REFERENCE TO RELATED APPLICATION

This application is a continuation of PCT application of PCT/JP2005/022699, which was filed on Dec. 9, 2005.

### BACKGROUND OF THE INVENTION

1. Field of the Invention

The present invention relates to a technique for extracting data that satisfies a designated extraction condition from among obtainable data.

2. Description of the Related Art

Currently, a data extraction apparatuses capable of extracting discretionary data from among obtainable data are widely used for various purposes. They are used as search engines in search of information disclosed on the Internet. Using the data extraction apparatus, a user is enabled to obtain a desired piece of data quickly from a large volume thereof.

The data extraction apparatus extracts data in units of a predetermined amount. The unit is constituted by, for example, a file or a record. A document or a Web page on the Internet corresponds to the file. The usage at actual point of sale (POS) data of a customer and the handheld terminal (HHT) data are usually managed using a single record as the management unit.

FIG. 1 is a diagram describing a conventional data extraction method. In the following, the data extraction method is specifically described by referring to FIG. 1.

The conventional data extraction method shown in FIG. 1 exemplifies the practices of a credit card company. “JOURNAL” represents a journal file storing fact data in units of records. “MASTER” represents a master file storing, in units of records, the data of the customer who is the holder of the credit card. As such, the data extraction method shown in FIG. 1 exemplifies the joining of the desired pieces of data from the journal files and the master files, both of which exist in plurality, by using Structural Query Language (SQL) and extracting a desired record from the joining result.

The respective conditions of the journal files and master files to be joined are described in the WHERE phrase within the FROM phrase. In accordance with the described condition, the current item of the master files is selected, and the item of the year 2004 is selected. The FROM phrase within the FROM phrase describes that the correlation of records between files is identified by the credit card number. The data items stored in a record extracted from the joining result are described in the SELECT phrase. The items described therein are the customer's name (V.NAME), the customer's age (V.AGE), the number of usages (V.SALES_NUM), and the amount of sales (V.SALES). The condition of a record to be extracted from the joining result is described in the WHERE phrase. The condition described therein lists the category of the card as a gold card. Based on the above descriptions, the record of a customer who has used a gold card in the year 2004 and currently holds it is extracted as the search result.

In order to differentiate a record extracted from the joining result, an extraction condition described in the WHERE phrase is changed. In order to extract the record of a customer holding a silver card, the description “COLD” is changed to “SILVER”, as shown in FIG. 2 as an example. This will extract the record of a customer who has used a silver card in the year 2004 and currently holds it.

As described above, the conventional data extraction method is configured to determine an extraction condition for obtaining desired data and to carry out a search for each of the extraction conditions. Therefore, there has been a problem in which the length of time required for obtaining all extraction results increases with the number of purposes for extracting data, that is, with the number of extraction conditions to be used for the search, thereby precluding the execution of work efficiently.

Currently, the kinds of information that are handled in digital data formats and the volume thereof are greatly on the increase. It is therefore predictable that the conventional data extraction method will not be capable of responding to such a situation in the future. This is another reason for the importance of being able to obtain all of the necessary kinds of data quickly even from a vast amount thereof.

Patent document 1: Laid-Open Japanese Patent Application Publication No. 2002-222194

Patent document 2: Laid-Open Japanese Patent Application Publication No. 2005-70911

Patent document 3: Laid-Open Japanese Patent Application Publication No. H06-319906

### SUMMARY OF THE INVENTION

The purpose of the present invention is to provide a technique for making it possible to obtain all of the necessary kinds of data quickly even from a vast amount thereof.

According to first and second aspects of the present invention, respective storage media are accessed by a computer that can be used as a data extraction apparatus capable of extracting data satisfying a designated extraction condition from among obtainable data, and stores a program to realize the following functions.

The program according to the first aspect implements the functions of: a acquisition function for obtaining the data; an input function for inputting the extraction condition; an extraction function for extracting data for each of the extraction conditions by using one or more extraction conditions input by the inputting function; and an output function for outputting the data extracted by the extraction function for each of the extraction conditions to an individually different output destination.

The program according to the second aspect implements the functions of: a acquisition function for obtaining the data; an input function for inputting the extraction condition; and an extraction function for dividing a conditional expression constituting the extraction condition input by the input function into a plurality of partial conditional expressions, converting the extraction condition into a form expressed by a combination of the partial conditional expressions obtained by the division, and validating whether or not the partial conditional expressions are satisfied in units of the partial conditional expression, thereby extracting data satisfying the extraction condition from among data obtained by the acquisition function.

A data extraction method according to the present invention, premised on being applied to extracting data satisfying a designated extraction condition from among obtainable data, comprises: making it possible to input a plurality of extraction conditions of which the kinds of target data are different; extracting data for each of the extraction conditions when one or more of the extraction conditions are input; and outputting the data obtained by the extraction to the respective output destinations corresponding to the extraction condition satisfied by the data.

The present invention is contrived to make it possible to input a plurality of extraction conditions in which the target data are different; to extract data for each of the extraction conditions when one or more extraction condition are input; and to output the data obtained by the extraction to an output destination corresponding to the extraction condition satisfied by the data.

This contrivance enables a user to obtain a plurality of extraction results at once by defining and inputting a plurality of extraction conditions. This enables the user to obtain all necessary extraction results quickly. As a result, high work efficiency is also accomplished easily.

The present invention is also contrived to divide a conditional expression constituting an input extraction condition into a plurality of partial conditional expressions, to change each extraction condition to a form expressed by a combination of the partial conditional expressions obtained by the division, and to validate as to whether or not the data satisfies the partial conditional expression in units of partial conditional expression, thereby extracting data satisfying the extraction condition from among all the data. The conversion of the extraction condition into a form expressed by a combination of partial conditional expressions makes it possible to avoid the need to validate whether or not the data satisfies the partial conditional expression for each conditional expression even if the same partial conditional expression exists in different conditional expressions. Therefore, it makes it possible to extract data with a smaller load.

### BRIEF DESCRIPTION OF THE DRAWINGS

FIG. 1 is a diagram describing a conventional data extraction method;

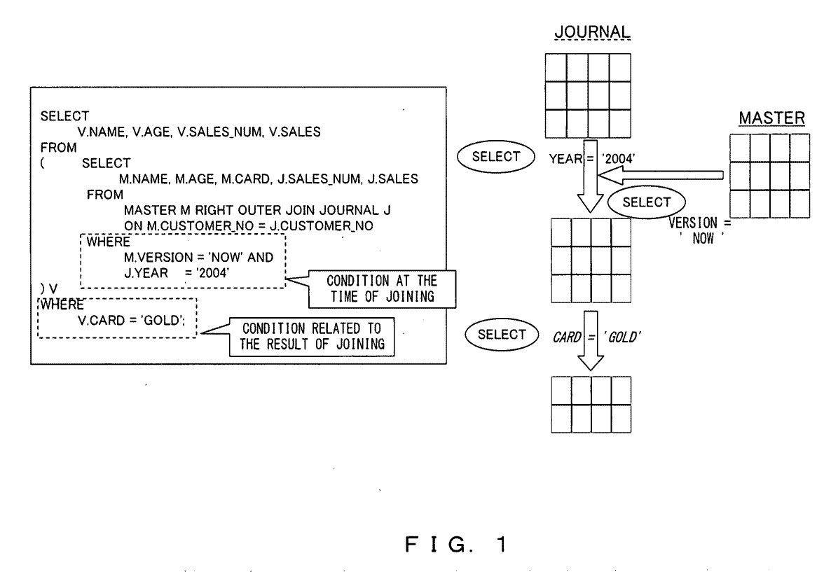

FIG. 2 is a diagram describing the difference in an extraction condition for extracting different kinds of data via a conventional data extraction method;

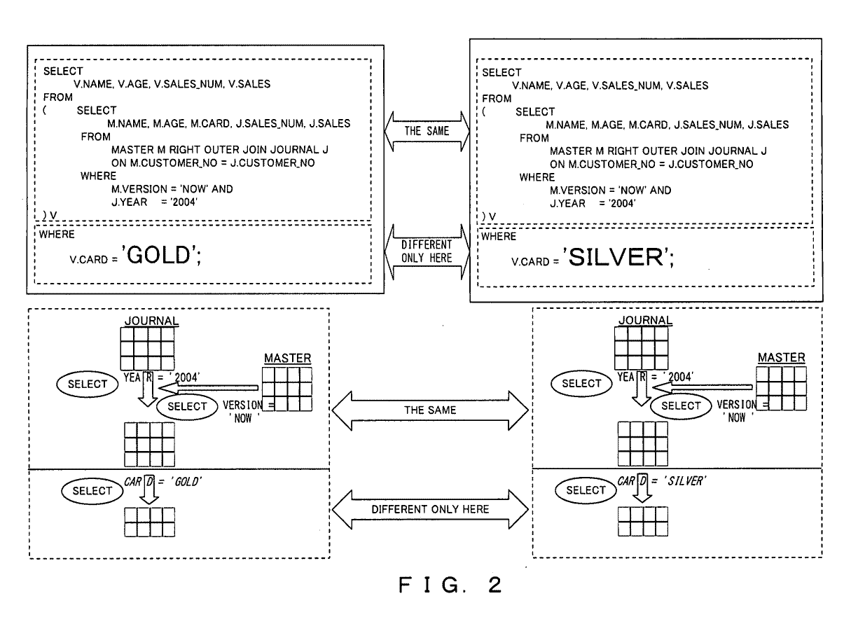

FIG. 3 is a diagram describing the functional configuration of a data extraction apparatus according to the present embodiment;

FIG. 4 is a diagram describing a data extraction enabled for a data extraction apparatus 100 according to the present embodiment;

FIG. 5 is a diagram exemplifying the hardware configuration of a computer capable of implementing a data totaling apparatus according to the present embodiment;

FIG. 6 is a diagram describing an example of the configuration of XML data;

FIG. 7 is a diagram describing an example of the configuration of CSV data;

FIG. 8 is a diagram describing the content example of an extraction condition group;

FIG. 9 is a diagram describing a tag DFA example;

FIG. 10 is a diagram describing a layer collation NFA example;

FIG. 11 is a diagram describing a CSV analysis DFA example;

FIG. 12 is a diagram describing a key word DFA example;

FIG. 13 is a diagram describing a logic table example;

FIG. 14 is a diagram describing the management method for an output buffer;

FIG. 15 is a flow chart of the process carried out by an extraction condition input unit 110;

FIG. 16 is a flow chart of the process carried out by a data input structure search unit 120;

FIG. 17 is a flow chart of the process carried out by an extraction condition judgment unit 130;

FIG. 18 is a flow chart of the process carried out by a data judgment unit 140;

FIG. 19 is a diagram describing an application example of a data extraction apparatus according to the present embodiment (part 1);

FIG. 20 is a diagram describing an application example of a data extraction apparatus according to the present embodiment (part 2);

FIG. 21 is a diagram describing an application example of a data extraction apparatus according to the present embodiment (part 3);

FIG. 22 is a diagram describing an application example of a data extraction apparatus according to the present embodiment (part 4);

FIG. 23 is a diagram describing an application example of a data extraction apparatus according to the present embodiment (part 5); and

FIG. 24 is a diagram describing an application example of a data extraction apparatus according to the present embodiment (part 6).

### DESCRIPTION OF THE EMBODIMENTS

The following is a description, in detail, of the preferred embodiment of the present invention by referring to the accompanying drawings.

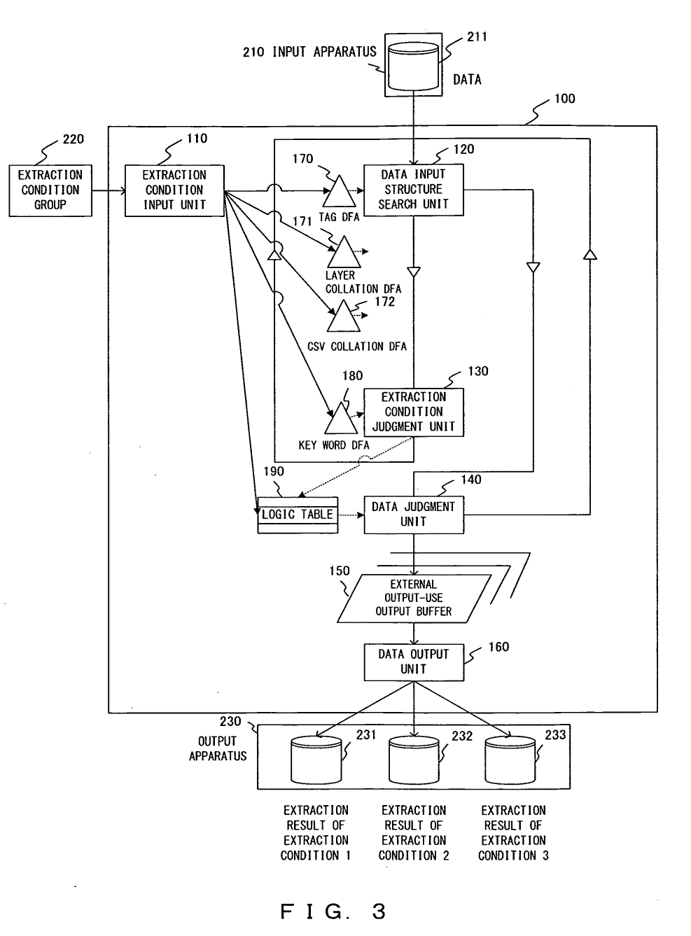

FIG. 3 is a diagram describing the functional configuration of a data extraction apparatus according to the present embodiment.

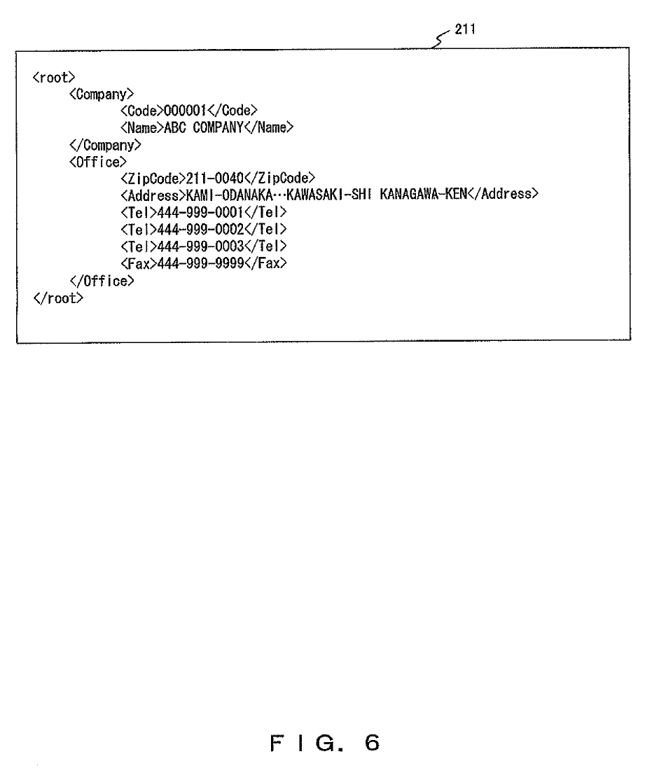

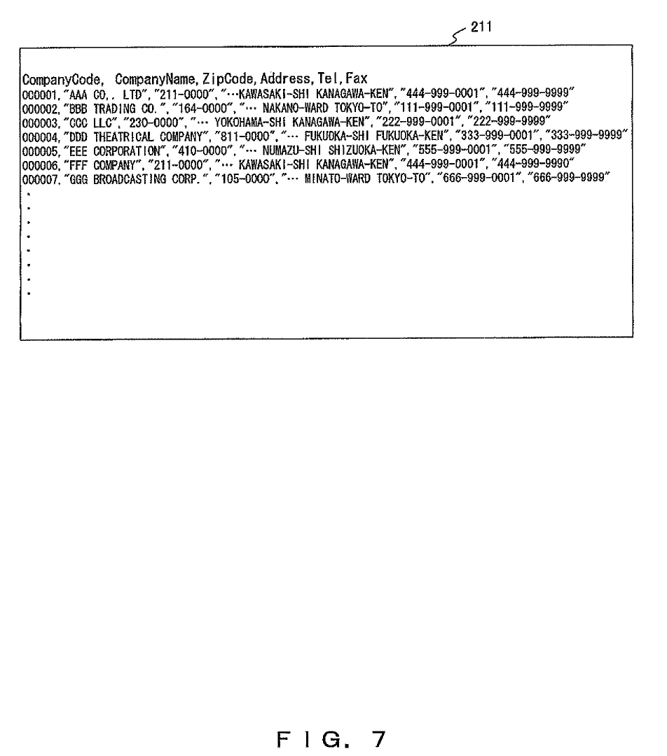

The data extraction apparatus 100 is implemented as means for inputting text data as data 211 from an input apparatus 210 and outputting the data 211 sorted by a designated extraction condition group 220. To this end, the data extraction apparatus 100 comprises an extraction condition input unit 110, a data input structure search unit 120, an extraction condition judgment unit 130, a data judgment unit 140, an external-output-use output buffer 150, and a data output unit 160. For convenience of description, the data 211 to be input from the input apparatus 210 is assumed in the present specification to be only eXtensible Markup Language (XML) data as shown in FIG. 6 and Comma Separated Values (CSV) data as shown in FIG. 7. These kinds of data are both text data.

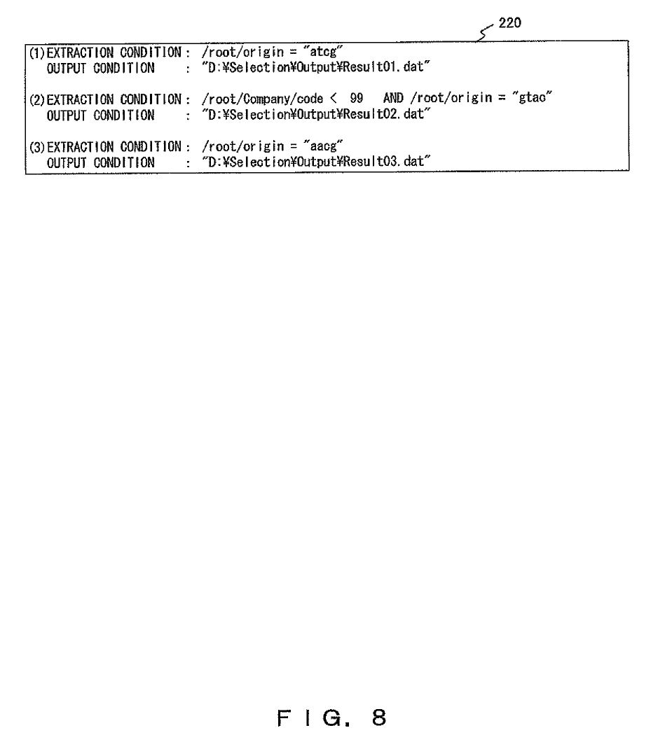

The extraction condition group 220 input by the extraction condition input unit 110 has, for example, the content shown in FIG. 8. Extraction condition and output condition are respectively shown in paragraphs (1) through (3) separately in FIG. 8. All of such separately shown extraction conditions are for a user to extract the desired data 211. The output condition shown together with the extraction condition is for designating both the output destination of the data 211 extracted by the extraction condition and the file name. As such, the extraction condition group 220 is configured to designate the extraction condition to be satisfied by the data 211, and the file name of the output destination, both for each piece of the desired data 211. The reason for thusly configuring in order to enable the designation of the output destination of the data 211 is to make it possible to quickly utilize the data 211 in a desired format. The extraction condition described in paragraph (1) is expressed by “extraction condition 1” in the following specification. Similar expressions are applied to other parts.

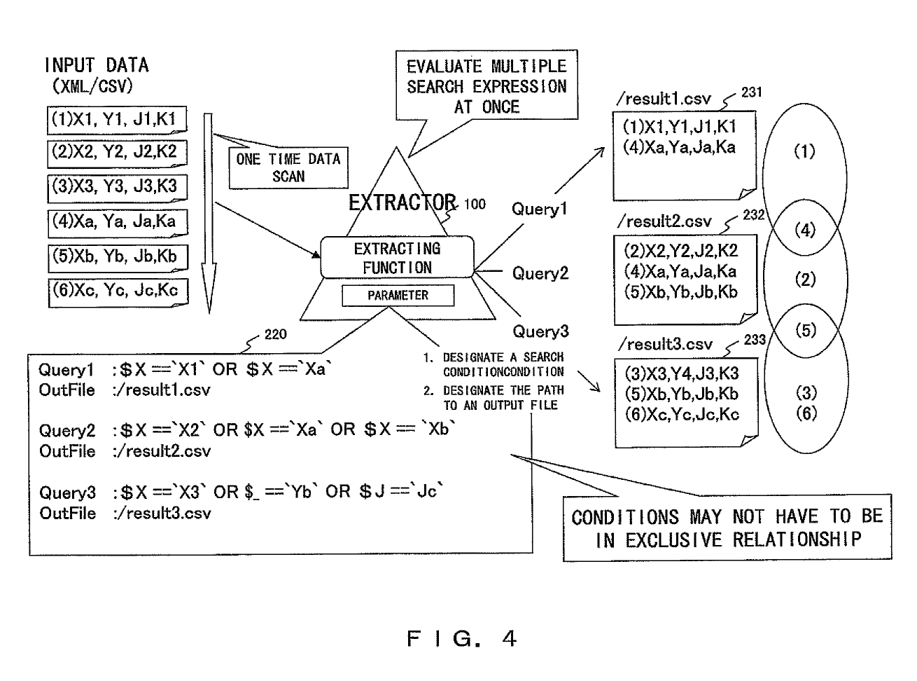

FIG. 4 is a diagram describing a data extraction enabled for a data extraction apparatus 100 according to the present embodiment. Next is a specific description of the data extraction by referring to FIG. 4.

The extraction condition group 220 shown in FIG. 8 assumes that the data 211 is XML data. In contrast, FIG. 4 shows an extraction condition group 220 assuming the CSV data. “Query” corresponds to an extraction condition, and “OutFile” corresponds to an output condition. “$X” expressed as a Query (i.e., an extraction condition) indicates an item name “X” and the “$_” indicates a discretionary item name. With these descriptions, “$X==‘X’ OR $X==‘Xa’ ” expressed in, for example, Query 1 indicates that the data 211 in which the data of the item name “X” is either X1 or Xa is the target of extraction. In the Query in which the expression is “$_==‘Xa’ ”, the data 211 in which an Xa exists as the data of a discretionary item is the target of extraction. If the data 211 is either of the XML data or the CSV data, the data may be input in a lump as a file or piece by piece in sequence. In the case of inputting the data piece by piece, the XML data looks like FIG. 6 and the CSV data looks like the rows expressing “000001” through “000007” at the head as shown in FIG. 7. For convenience of description, the congregation of these pieces of data is called a record in the following description. Further, the character string described between two single quotes (‘ ’) is called a “key word”. The key word corresponds to the character string described between two double quotes (“ ”) in the extraction condition group 220 shown in FIG. 8.

The present embodiment is configured to extract data 211 satisfying any of the designated extraction conditions in the extraction condition group 220 by using a character string collation method and to output the data 211 to the file of an output destination file name designated by the output condition correlated with the satisfied extraction condition. By so doing, the data 211 satisfying Query 1 is output to the file 231 having the file name “result1.csv”, the data 211 satisfying Query 2 is output to the file 232 having the file name “result2.csv”, and the data 211 satisfying Query 3 is output to the file 233 having the file name “result3.csv”. The correlations between the input data 211 and the data 211 output to any of the files 231 through 233 are shown in paragraphs (1) through (6) in the drawing.

Since each of the extraction conditions is individually considered, an extraction condition can be discretionarily defined. Therefore, one or more extraction conditions can be defined for each category of the data 211, such as the XML data and CSV data, and further, one or more extraction conditions can be defined for each of the structures. Therefore, no matter how the schema is different between two pieces of target data 211, the influence of the difference can be avoided without fail.

Based on the above description, an exclusive relationship may not be required between extraction conditions. Therefore, Query 1 and Query 2 have content for respectively extracting pieces of data 211 satisfying the conditional expression (logic expression) “$X==‘Xa’ ”. Query 3 and Query 4 likewise have content for respectively extracting pieces of data 211 satisfying the conditional expression “$X==‘Xb’”. As a result of this, the data 211 describing (4) is output to both the files 231 and 232, and the data 211 describing (5) is output to both the files 232 and 233.

As such, the configuration is such that the designation of a plurality of extraction conditions by way of the extraction condition group 220 causes the data 211 satisfying an extraction condition to be output to the designated output destination by being sorted in accordance with the extraction condition. Therefore, the user is enabled to obtain a plurality of extraction results at once just by defining a plurality of extraction conditions and output conditions as the extraction condition group 220. This makes it possible to obtain all necessary extraction results more quickly, which in turn results in high work efficiency being easily accomplished.

As described above, the present embodiment adopts the character string collation method, which is a method collating between the character string designated by an extraction condition and the target data 211 sequentially from the head of the data to the tail, thereby examining whether or not the character string exists in the data 211. In the character string collation method, it is possible with only one scan from the head to tail to validate which of the extraction conditions defined by the extraction condition group 220 is satisfied by the data 211. This accordingly makes it possible to quickly extract the data 211 to be extracted without fail regardless of the number of defined extraction conditions. The reference documents for the character string collation method include, for example, the patent documents 1 and 2.

Now the description returns to FIG. 3.

The extraction condition input unit 110 inputs an extraction condition group 220 as described above and generates a corresponding automaton by analyzing the extraction condition for each extraction condition, and thereby a tag Deterministic Finite state Automaton (DFA) 170, a layer collation Non-deterministic Finite state Automaton (NFA) 171, and a key word DFA 180 are generated if the extraction condition is for XML data use. If the extraction condition is for CSV data use, a CSV analysis DFA 172 and a key word DFA 180 are generated. A logic table 190, as in the case of the key word DFA 172, is generated regardless of the kind of data 211 assumed in the extraction condition.

The extraction condition group 220 is essentially generated by the user inputting data. When, for example, generating an extraction condition group 220 at a terminal apparatus connected to a data extraction apparatus according to the present embodiment, the user displays a display screen used for generating the extraction condition group 220 and inputs it by the desired content in the display screen. Instructing a data extraction after the input causes the generated extraction condition group 220 to be output to the data extraction apparatus 100.

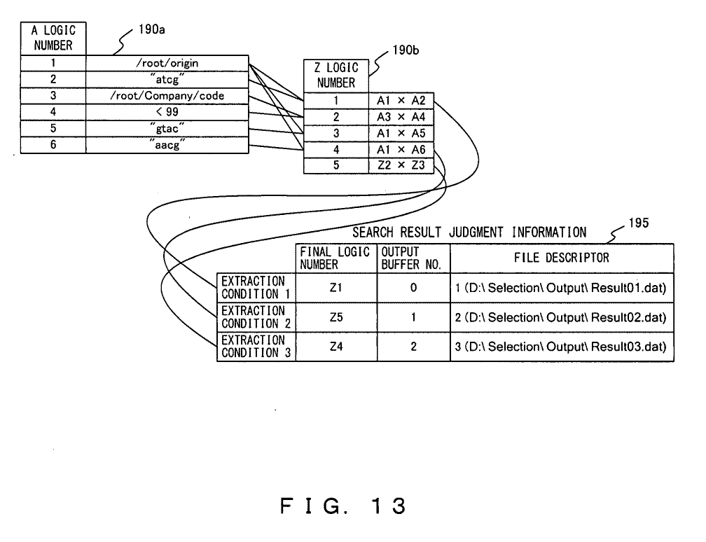

As for the logic table 190, if the extraction condition group 220 is the content shown in FIG. 8, the extraction condition input unit 110 generates the content as shown in FIG. 13. The logic table comprises an A logic table 190a and a Z logic table 190b, as shown in FIG. 13.

The A logic table 190a is configured to divide a conditional expression (i.e., a logic expression) constituting the extraction condition by means of a relational operator(s) (which corresponds to “=” and “<” in FIG. 8) into smaller subdivisions by using the logic expressed by the conditional expression (that is, in FIG. 8, the conditional expression “/root/Company/code<99” is disassembled to “/root/Company/code” and “<99”), and to attach a specific logic number for each of the subdivided conditional expressions (i.e., partial conditional expressions). The Z logic table 190b is configured to express a conditional expression or extraction condition by a combination of logic numbers attached to the partial conditional expressions or to the conditional expressions. The logic numbers to be combined may be the numbers from either the A logic table 190a or Z logic table 190b. The configuration is such that a record (i.e., a row) to be referred to in the A logic table 190a or Z logic table can be identified by expressing a conditional expression or extraction condition by using the logic number(s). While it is not specifically delineated in the drawing, the Z logic table is configured to make it possible to store a sign showing whether the conditional expression or extraction condition is expressed by the combination for each of the combinations of logic numbers. In order to differentiate the logic numbers respectively assigned in the logic tables 190a and 190b, “A” is attached to the head for the logic number of the A logic table 190a, while “Z” is attached to the head for the logic number of the Z logic table 190b in the following description.

The combination to which the logic number Z1 is assigned in the Z logic table 190b is “A1×A2”. The combination “A1×A2” has a logic expression in a form showing that the partial conditional expression (/root/origin) of the logic number A1 applies and also that the data 211 in which the partial conditional expression (“atcg”) of the logic number A2 applies is the target of extraction. Because of this, the “x” within the combination (logic expression) “A1×A2” is a logic operator indicating performing the logic product of partial conditional expressions of the logic numbers A1 and A2. The logic expression represents the content of the extraction condition 1. Likewise, the respective logic expressions of the logic number Z4 and Z5 represent the respective contents of the extraction conditions 3 and 2. The extraction condition 2 is Z5=Z2×Z3. Here, based on Z2=A3×A4 in the table of 190b, the correspondences are A3=/root/Company/code and A4=<99.

Further, based on Z3=A1×A5, the correspondences are A1=/root/origin and A5=“gtac”. Therefore, the extraction condition 2 corresponds to the A logic numbers A3, A4, A1 and A5, and the logic product (i.e., AND) of the extraction condition 2 shown in FIG. 8 is indicated by the link between the logic table and its elements shown in FIG. 13. The extraction condition 3 shown in FIG. 8 is indicated by the link connecting the extraction condition 3, the Z logic table number 4, the logic table of the A logic numbers A1 and A6, and the elements, which are shown in FIG. 13. That is, the extraction condition 3 corresponds to the A logic number as Z4=A1×A6 (A1=/root/origin, A6=“aacg”). That is, the use of the logic table formed by each extraction condition by way of these logic numbers makes it possible to discern data for each extraction condition.

The search result judgment information 195 shown in FIG. 13 is information that has put together the logic number assigned to a combination of logic numbers expressing the extraction condition for each extraction condition, the number (which is expressed as “output buffer No.” in the drawing) indicating the output buffer 150 in which the data 211 satisfies the extraction condition, and a file descriptor (i.e., a correlated output condition). By configuring as such, the data 211 satisfying any of the extraction conditions is output to the output buffer 150 by referring to the search result judgment information 195, followed by being output to a file.

The automatons (i.e., the tag DFA 170, layer collation NFA 171, keyword DFA 180 and CSV analysis DFA 172) are each a state transition table for collating the character string with a search condition with the data 211. A transition between states is expressed by combining the direction of transition with an arrow. With the head being the initial state, the states are sequentially shifted in accordance with the character string of the data 211, starting from the initial state. The state to be shifted to includes one or more accepting states equivalent to the character positioned last in the character string within the search condition. By way of this configuration, the automaton is generated so as to transition to any of the accepting states if a character string to be detected exists in the data 211. The configuration includes outputting of the information of a “hit” (“hit information”) in accordance with the accepting state when transitioning to the accepting state. The hit information, being specific in accordance with the accepting state to transition to, is also generated when generating an automaton.

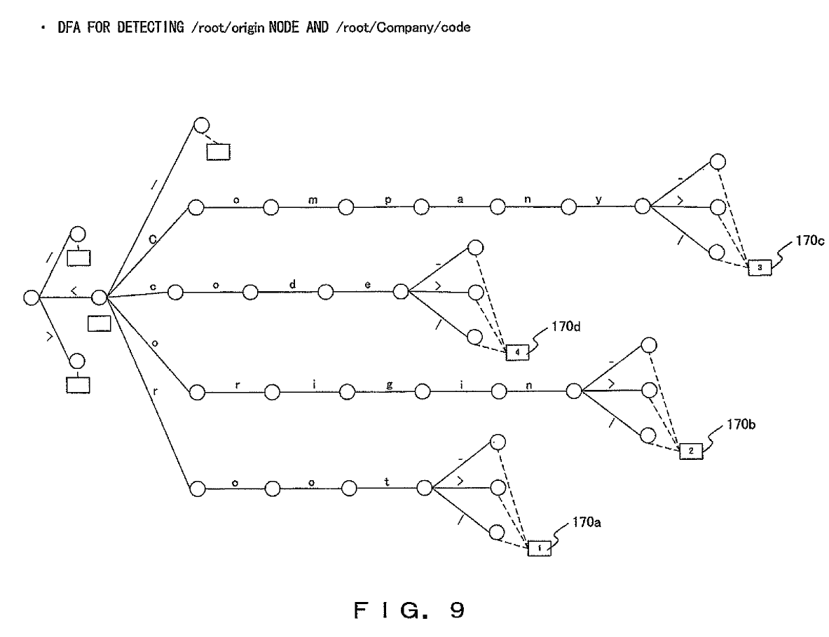

The tag DFA 170 is for detecting a search path to an element in which the character string (i.e., the content of an element; noted as “element content” hereinafter) is to be collated with a keyword. If the extraction condition group 220 is the content shown in FIG. 8, the extraction condition input unit 110 eventually generates a tag DFA 170 as shown in FIG. 9. In the extraction condition group 220 shown in FIG. 8, “/root/origin” and “/root Company/code” exist as the search path, and therefore the tag DFA 170 is generated so as to make it possible to detect the character strings “root”, “origin”, “Company” and “code”, which are tag names, respectively. Transitioning to the accepting state corresponding to any of the characters “t”, “n”, “y” and “e” that are positioned at the respective tail ends of these character strings causes pieces of the hit information 170a through 170d that indicate that a character string corresponding to the character has been detected to be output.

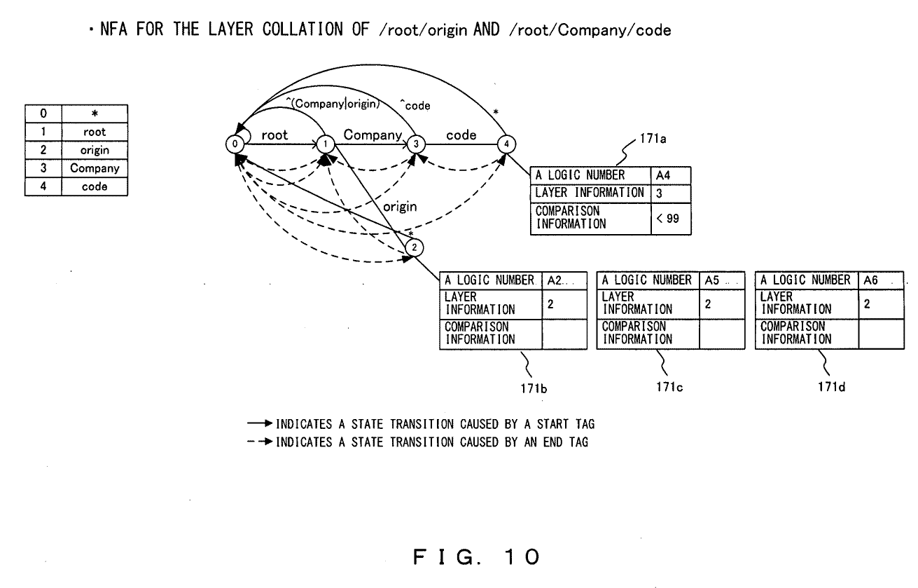

The layer collation NFA 171 is for managing the currently targeted search path. If the extraction condition group 220 has the content shown in FIG. 8, the extraction condition input unit 110 eventually generates a layer collation NFA 171 as shown in FIG. 10. The layer collation NFA 171 is generated so that a state transition is performed in units of the tag names described in any of the search paths as shown in FIG. 10. Therefore, the state transition is caused by a start tag and an end tag. Here, the states represented by “4” and “2” are applicable to the accepting state.

The transition to the accepting state represented by “4” means that a search path “/root/Company/code” has been detected. This prompts the node designated by the search path to output the hit information 171a for collating whether or not the value is smaller than “99”, that is, whether or not the partial conditional expression (logic) of the logic number A4 applies. The hit information 171a is configured to include the logic number (i.e., “A4” in this case) indicating the partial conditional expression as the target of collation, the layer information indicating the depth of the layer of the search path, and the comparison information (i.e., “<99” in this case) indicating the content for which the relationship is to be validated by using the partial conditional expression. Likewise, the transition to the accepting state represented by “2” means that the search path “/root/origin” has been detected and therefore this prompts a node designated by the search path, that is, the tag by the tag name “origin”, to output the hit information 171b through 171d for collating whether or not the character string is identical with “atcg”, “gtac” and/or “aacg”. The reason that these pieces of the hit information 171b through 171d do not indicate comparison information is that the collation of the partial conditional expressions corresponding to the logic numbers expressed in pieces of the hit information are performed by the key word DFA 180.

A state transition at the layer collation NFA 171 is carried out by using the tag DFA 170 shown in FIG. 9. If, for example, the character string “root,” which is a tag name, is detected by using the tag DFA 170, that is, if the hit information 170a is output by using the tag DEA 170, the layer collation NFA 171 transitions from the initial state representing “0” to the state representing “1”. Then, when the tag DFA 170 detects a character string “origin”, the NFA 171 transitions from the state representing “1” to the state representing “2”. In this event, the tag DFA 170 detects a character string “Company”, and the NFA 171 transitions from the state representing “1” to the state representing “3”. If any of these characters cannot be detected by the tag DFA 170, the NFA 171 transitions from the state representing “1” to the initial state representing “0”. By so transitioning, it is possible to grasp the presence or absence of the movement of a layer along the search path by using the layer collation NFA 171 and to manage the target search path.

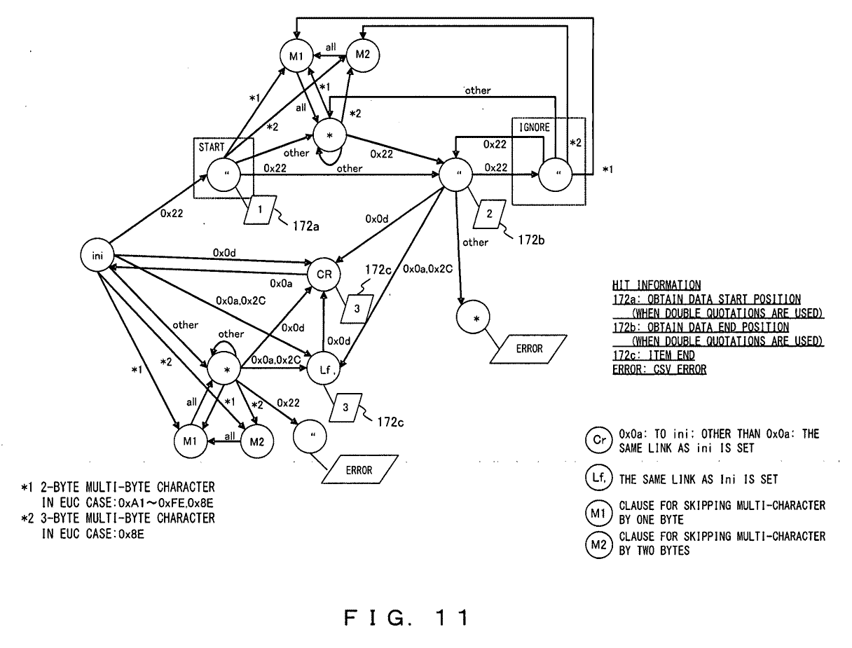

The CSV analysis DFA 172 is for detecting the search path to an element in which a character string (i.e., an element content) is to be collated with the key word. In the CSV data in which the element exists between two double-quote marks (refer to FIG. 7), a CSV analysis DFA 172 as shown in FIG. 11 is generated by the extraction condition input unit 110. The “0x” expressed within FIG. 11 means that the symbol following it is a hexadecimal expression.

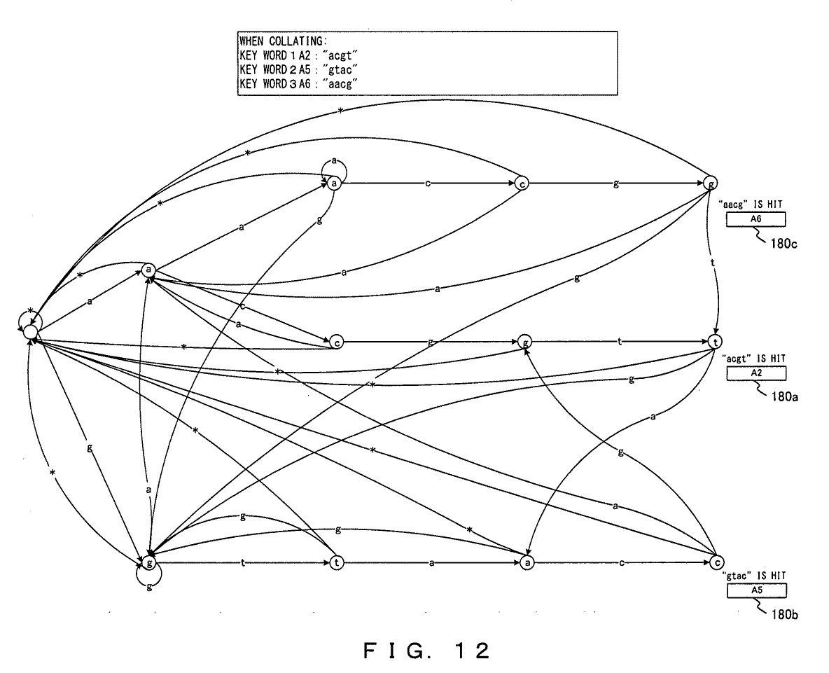

The key word DFA 180 is for extracting a character string identical with the designated key word by the extraction condition. If the extraction condition group 220 is the content shown in FIG. 8, the extraction condition input unit 110 eventually generates a key word DFA 180 as shown in FIG. 12. When transitioning to an accepting state corresponding to the character positioned at the tail end of either of the key words registered in it, that is, when any of the character strings “aacg”, “acgt” and “gtac” is successfully detected, any one of the pieces of hit information 180a through 180c is output in accordance with the detected character string.

The data input structure search unit 120 inputs data 211 from the input apparatus 120 continuously by a predetermined amount and determines an automaton to be used for collation in accordance with the kind of data 211. Accordingly, if the data 211 is the XML data, the search path described in any of the extraction conditions is detected by using the tag DFA 170 and layer collation NFA 171. If the data 211 is the CSV data, the item name described in any of the extraction conditions is detected by using the CSV analysis DFA 172. When the search path or the item name is detected, the node designated by the search path or the data position information indicating the position at which the cell of the item name starts, and the node cell information indicating the detected character string are reported to the extraction condition judgment unit 130. These pieces of information are for generating, for example, hit information or information including the hit information. These pieces of information are reported until the tail end of the data 211 is detected or every time a search path or an item name is detected. The detection of the tail end is equivalent to the detection of an end tag paired with the root tag for the XML data, and to the detection of a predefined number of cells. The detection of a search path or that of an item name is equivalent to a validation that the partial conditional expression stored in the A logic table 190a applies.

The extraction condition judgment unit 130 performs, by using the key word DFA 180, a collation from the data position indicated by the data position information reported from the data input structure search unit 120. If the existence of a character string identical with either of the key words, that is, the existence of a value (i.e., the value less than “99” for the extraction condition group 220 shown in FIG. 8) that satisfies the relationship represented by the relational operator, is validated in the data position as a result of the collation, the extraction condition judgment unit 130 stores the sign (noted as “true sign”; also noted as “false sign” for a different sign) indicating the aforementioned validation at the location of the applicable logic number within the Z logic table 190b). If the tail end of the data 211 is detected before the aforementioned validation is successfully performed, it reports the data position information indicating the position of the tail end to the data input structure search unit 120. This prompts the data input structure search unit 120 to report to the data judgment unit 140 that the scan is completed to the tail end, regardless of whether the data input structure search unit 120 detects the tail end of the data 211.

The extraction condition judgment unit 130 sends the above described report or performs, by using the key word DFA 180, a collation until the data input structure search unit 120 detects the tail end every time the information is reported from the data input structure search unit 120. If the data 211 satisfies the extraction condition 2 as a result, the true signals, as the signs of the logic numbers Z2 and Z3, are sequentially stored, and the true sign as the sign of the logic number Z5 is eventually stored. As such, the true sign is stored only at the location of the logic number at which the targeted data 211 satisfies the logic expression, and therefore the reference to the Z logic table 190b makes it possible to validate the extraction condition satisfied by the data 211.

As described above, the present embodiment is configured to subdivide the conditional expression constituting an extraction condition and to perform a collation by units of partial conditional expressions (i.e., subdivided logic) obtained by the subdivision. With this configuration, the detection of an identical character string or search path, the validation of the relationship represented by the relational operator, and the identification of the location to which such processes are to be applied are individually carried out. Such a configuration enables a further flexible response, and enables the user to further easily define the desired content satisfied by the data 211 from the obtained information as an extraction condition even though the kind of data 211 and the information of the structure of the data are missing. Therefore, a further convenience is attained for the user.

A partial conditional expression (i.e., subdivided logic) sometimes exists separately in the same or another extraction condition. In the example of FIG. 8, the partial conditional expression “/root/origin” is described in all of the extraction conditions 1 through 3. Such a plurality of the same descriptions, however, can be kept as one partial conditional expression by subdividing the conditional expression. This makes it possible to suppress, to a minimum, the number of partial conditional expressions for which whether or not they apply is to be validated regardless of the number and/or the contents of the extraction conditions. A conditional expression or an extraction condition is expressed by the combination of a plurality of partial conditional expressions. Therefore, it is possible to quickly validate whether or not those apply.

The data judgment unit 140 refers to the Z logic table 190b and validates an extraction condition which the data 211 satisfies. When it becomes clear that any extraction condition is satisfied as a result of the validation, the data judgment unit 140 refers to the search result judgment information 195 (refer to FIG. 13) and outputs the data 211 to the output buffer 150 and store it therein.

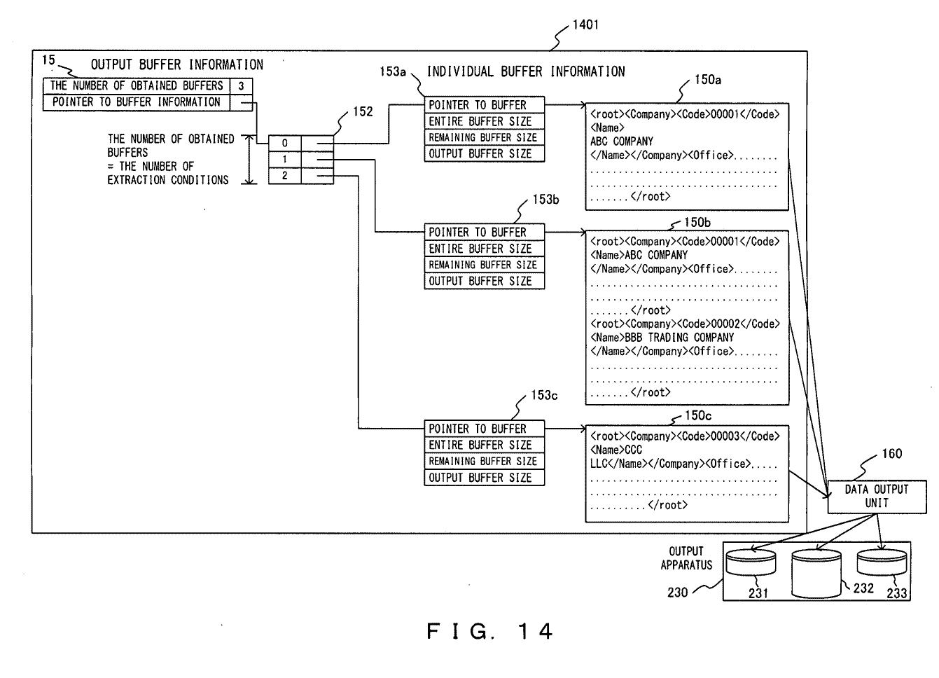

FIG. 14 is a diagram describing the management method for an output buffer.

An output to the output buffer 150 corresponding to data 211 is managed by the output buffer information 151 and buffer information 152. The output buffer information 151 comprises obtained buffer number information indicating the number of output buffers 150 secured by an extraction condition group 220 and pointer information for accessing the buffer information 152. The buffer information 152 comprises the number of records, which is indicated by the obtained buffer number information, with each record storing individual buffer information 153 (i.e., one of the pieces of individual buffer information 153a through 153c herein) including plural pieces of information. The areas storing these pieces of information, i.e., the output buffer information 151 and buffer information 152, along with the output buffer 150, are secured in a storage apparatus 1401, which is either incorporated in, or connected to, the data extraction apparatus 100. Also, the layer collation NFA 171, CSV analysis DFA 172, key word DFA 180, and logic table 190 are stored in, for example, the storage apparatus 1401.

The individual buffer information 153 comprises pointer information for accessing a corresponding output buffer 150, an entire buffer space amount indicating the entire amount of space available to store the data 211, a remaining buffer space amount indicating the remaining amount of space, of the entire amount of space, available to store the data 211, and an output buffer space amount indicating the size of the secured output buffer 150. The magnitude relationship of the number assigned to each record is the same as that of the number of the extraction condition. That is, record number “0” corresponds to the extraction condition 1. This configuration makes it possible to identity a record corresponding to the extraction condition satisfied by the data 211.

As described above, having referred to the Z logic table 190b and accordingly validated that the extraction condition satisfied by the data 211 exists, the data judgment unit 140 validates the extraction condition by referring to the search result judgment information 195 and refers to the output buffer information 151 and buffer information 152. By so doing, it extracts a record applicable to the validated extraction condition from the buffer information 152 and outputs the data 211 to the output buffer 150 designated by the individual buffer information 153 stored in the record. The remaining buffer size is updated by the size of the outputted data 211.

The data output unit 160 monitors, for example, the remaining buffer size of each output buffer 150 and, if the size becomes no more than a predefined value or if there is no longer any data 211 to be input from the input apparatus 210 and processed, outputs the data 211 stored in the output buffer 150 to the applicable file by referring to the search result judgment information 195. This process prompts the data 211 extracted so far to be stored in the file of the output destination file name designated by the output condition. Here, all three of the files 231 through 233 are stored in the same output apparatus 230.

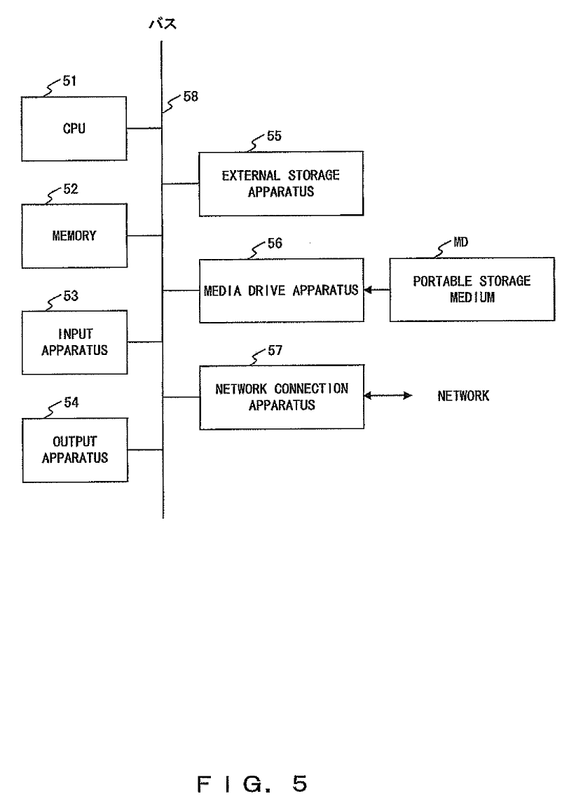

FIG. 5 is a diagram exemplifying the hardware configuration of a computer capable of implementing the data extraction apparatus 100. The extraction apparatus 100 may be implemented by using a plurality of computers (i.e., data processing apparatuses); here, the description is premised on the apparatus being implemented by using one computer, of which the configuration is shown in FIG. 5.

The computer shown in FIG. 5 comprises a central processing unit (CPU) 51, memory 52, an input apparatus 53, an output apparatus 54, an external storage apparatus 55, a media drive apparatus 56, and a network connection apparatus 57, with these components being interconnected by a bus 58. The configuration shown in FIG. 5 is just an example and it is not limited as such.

The memory 52 is memory such as random access memory (RAM) storing data temporarily. The memory 52 temporarily stores a program or data stored in a portable recording medium MD accessed by the external storage apparatus 55 or media drive apparatus 56. The CPU 51 reads the program from the memory 52 and executes the program, thereby performing the overall control. The program may be obtained by the network connection apparatus 57 by way of a network.

The input apparatus 53, being connected to, or comprising, an input device such as a key board and mouse, detects a user operation on such an input device and reports the detection result to the CPU 51.

The output apparatus 54, being connected to, or comprising, for example, a display, outputs the data sent by the control of the CPU 51 in the display.

The network connection apparatus 57 is for communicating with another apparatus by way of a network such as an intranet and the Internet. The external storage apparatus 55 is, for example, a hard disk apparatus and is mainly used for storing various kinds of data and a program.

The media drive apparatus 56 is for accessing to a portable storage medium MD such as a flexible disk, an optical disk (including CD-ROM, CD-R, DVD, or the like in this specification) and a magneto optical disk.

The output apparatus 230 shown in FIG. 3 is equivalent to the external storage apparatus 55, to the media drive apparatus 56 to which the recording medium MD is attached, or to an external apparatus accessible from the network connection apparatus 57 in the configuration shown in FIG. 5. The input apparatus 210 is equivalent to the media drive apparatus 56 to which the recording medium MD is attached, or to an external apparatus accessible from the network connection apparatus 57. The extraction condition group 220 can be input from the input apparatus 53, the media drive apparatus 56 to which the recording medium MD is attached, or the network connection apparatus 57. The storage apparatus 1401 shown in FIG. 14 is equivalent to at least, for example, either the external storage apparatus 55 or the memory 52.

The extraction condition input unit 110 is implemented by, for example, the respective units 51 through 53 and 55 through 58 (excluding the output apparatus 54). Both the data input structure search unit 120 and data output unit 160 are implemented by, for example, the respective units 51, 52, 55 through 57, and output apparatus 54 (excluding the input apparatus 53). Both the extraction condition judgment unit 130 and data judgment unit 140 are implemented by, for example, the respective units 51, 52, 55, 56 and 58 (excluding the input apparatus 53, output apparatus 54 and network connection apparatus 57).

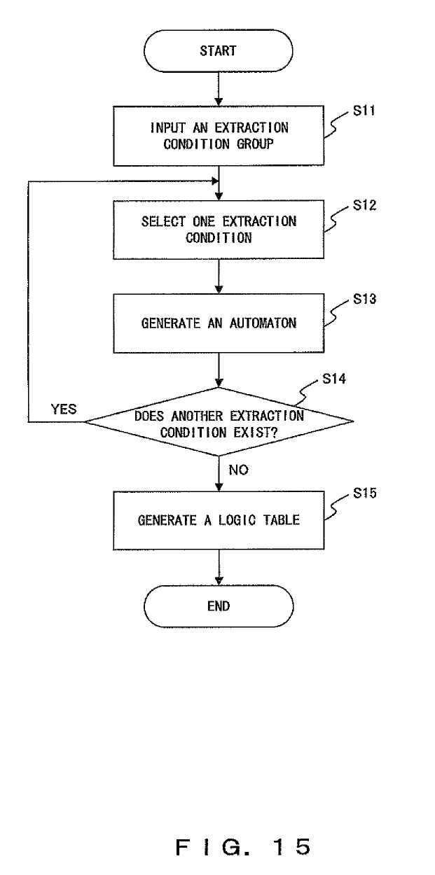

Next is a description of the operations, in detail, of the above described respective units 110, 120, 130 and 140 by referring to the flow charts of the respective processes shown in FIGS. 15 through 18. All of the processes are implemented by, for example, the CPU 51 reading the program stored in the external storage apparatus 55 or in the portable storage medium MD attached to the media drive apparatus 56 on to the memory 52 and executing the program.

FIG. 15 is a flow chart of the process carried out by the extraction condition input unit 110. First is a description of the process in detail by referring to FIG. 15. The process is initiated by the user instructing the input of, for example, an extraction condition group 220 by way of the input apparatus 53 or network. In this case, the extraction condition group 220 is input by way of the input apparatus 53 or network connection apparatus 57.

First in step S11 (also noted as “S11” hereinafter), the extraction condition group 220 is input and stored, for example, in the memory 52. In the subsequent step, S12, one extraction condition is selected, and read, from the stored extraction condition group 220 and the category of a corresponding automaton is identified by analyzing the extraction condition 1. In the next step, S13, the identified category of an automaton is generated or updated. The generation or update causes the character string described in the extraction condition to be registered in the tag DFA 170, layer collation NFA 171 or key word DFA 180 on an as required basis.

In S14 following S13, whether or not another unselected extraction condition exists in the extraction condition group 220 is judged. If such an extraction condition remains, the judgment is “yes”, the process returns to S12, and another selection condition is selected. Otherwise, the judgment is “no”, and the search result judgment information 195 (refer to FIG. 13), output buffer information 151, and buffer information 152 are then generated along with the generation of the logic table 190, and the output buffer 150 (refer to FIG. 14) is secured in accordance with the number of extraction conditions in S15. With this, the series of processes ends. As such, by inputting the extraction condition group 220, the preparation for outputting the data 211 to the output destination to be output is performed along with the generation of a necessary automaton.

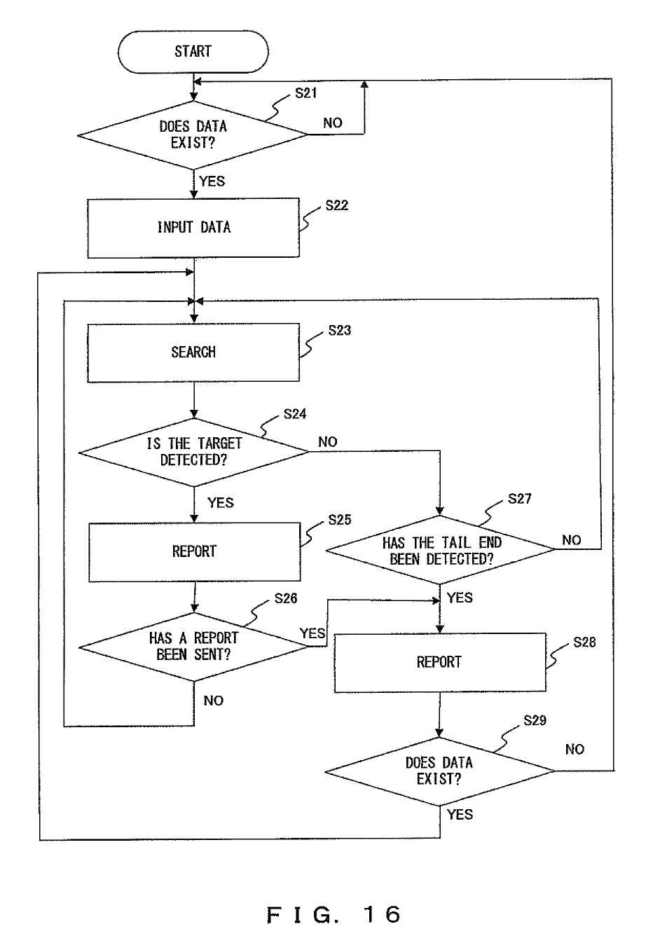

FIG. 16 is a flow chart of the process carried out by the data input structure search unit 120. Next is a description of the process in detail by referring to FIG. 16. The process is carried out during the import of data 211 from, for example, the input apparatus 210 being instructed.

First, in S21, whether or not the data 211 to be input from the input apparatus exists is judged. If such data 211 does not exist, the judgment is “no” and the judgment is made again. By so doing, the occurrence of the data 211 is awaited. In contrast, if such data 211 exists, the judgment is “yes” and the process shifts to S22.

In S22, a predetermined amount of data 211 is input from the input apparatus 210. In the subsequent step, S23, one piece of data is selected from the input data 211 and a character string identical with any of the character strings is registered in an automaton by using the automaton determined by the extraction condition input unit 110.

The search is carried out in units of characters and, upon finishing the search, the process shifts to S24 to judge whether or not the targeted character string (i.e., the search path, item name and such) has been successfully detected. If such a character string is not detected, the judgment is “no” and the process shifts to S27. Otherwise the judgment is “yes” and the process shifts to S25.

In S25, data position information and such are reported to the extraction condition judgment unit 130. With the report, the extraction condition judgment unit 130 performs a collation by using the key word DFA 180 and, if the tail end of the data 211 is detected as a result of the collation, reports the data position information. As a result, whether or not the report has been sent is judged in the subsequent step, S26. If the report is sent, the judgment is “yes” and the process shifts to S28. Otherwise the judgment is “no” and the process shifts to S23 to repeat the search.

In S27, to which the process shifts as a result of the judgment of S24 being “no”, whether or not the tail end of the data 211 has been detected as a result of the search is judged. If the tail end has been detected, the judgment is “yes” and the process shifts to S28. Otherwise, the judgment is “no” and the process shifts to S23 to continue the search.

In S28, the fact that the tail end of the data 211 has been detected is reported to the data judgment unit 140. In the subsequent step, S29, whether or not unselected data 211 exists in the input data 211 is judged. If the unselected data 211 exists, the judgment is “yes” and the process returns to S23 to start a search by selecting the unselected data 211. Otherwise the judgment is “no” and the process returns to S21. By so doing, whether or not data 211 to be input to the input apparatus 210 exists is validated.

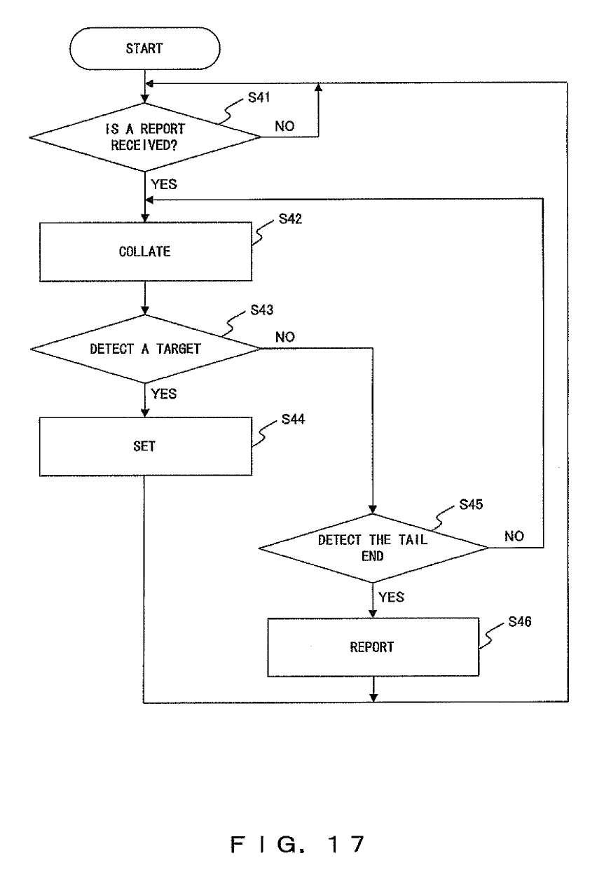

FIG. 17 is a flow chart of the process carried out by the extraction condition judgment unit 130. Next is a description of the process in detail by referring to FIG. 17.

First, in S41, the reception of the end report of a record is awaited. When the report is received, the judgment is “no”, the process shifts to S42, and a collation by using the reported data position information and the key word DFA 180 is carried out. In the subsequent step, S43, whether or not a character string identical to any of the key words registered in the key word DFA 180 has been detected is judged. If such a character string is detected, the judgment is “yes”, and a true sign is set to the location of the applicable login number in the logic table 190 (i.e., the Z logic table 190b) in S44. Then the process shifts to S41 and shifts to the state of waiting for a report. Otherwise the judgment is “no” and the process shifts to S45.

In S45, whether or not a tail end has been detected is judged. If the tail end is detected as a result of the collation, the judgment is “yes”, the data position information is reported to the data input structure search unit 120 in S46 to report that the tail end was detected, and the process shifts to S41. Otherwise, the judgment is “no” and the process shifts to S42 to continue collation.

Through the process as described above, the necessary information is exchanged between the data input structure search unit 120 and extraction condition judgment unit 130 as appropriate, and the respective processes are carried out by using these pieces of information. The configuration is such that an extraction condition applicable to a piece of data 211 is validated for each single piece thereof and such that the process according to the validation result is carried out.

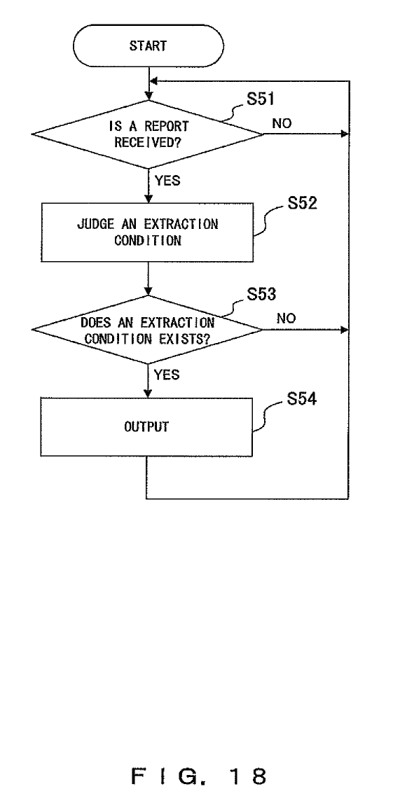

FIG. 18 is a flow chart of the process carried out by the data judgment unit 140. Lastly is a description of the process in detail by referring to FIG. 18.

First, in S51, a report of the tail end of data 211 to be sent from the data input structure search unit 120 is awaited. When the report is received, the judgment is “no”, the process shifts to S52 to refer to the logic table 190, and an extraction condition satisfied by the presently targeted data 211 is judged. Then the process shifts to S53.

In S53, whether or not an extraction condition satisfied by the data 211 exists is judged. If such an extraction condition exists, the judgment is “yes” and the process shifts to S54, the data is output to the output buffer 150 by referring to the search result judgment information 195 (refer to FIG. 13), output buffer 151 and buffer information 153 (refer to FIG. 14), and the corresponding individual buffer information 153 is updated and then the process returns to the S51. With this, the process returns to the state of waiting for a report. Otherwise, the judgment is “no” and the process returns to S51.

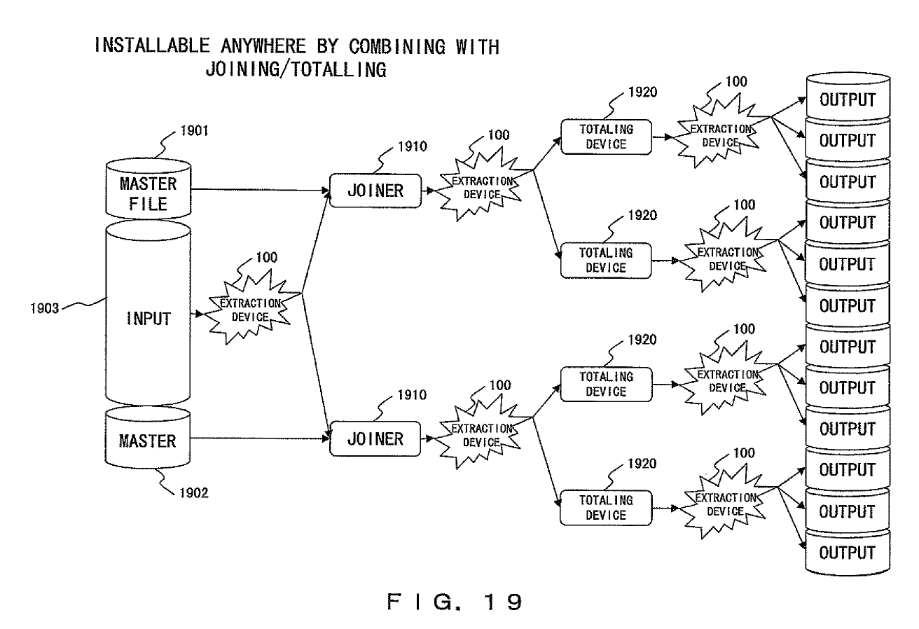

FIGS. 19 through 24 are diagrams describing the application examples of the data extraction apparatus. The following are descriptions in specific of the applicable utilization methods of the apparatus by referring to FIGS. 19 through 24. In FIGS. 19 through 24, the data extraction apparatus is shown as “extraction device”.

FIG. 19 exemplifies the case of using a plurality of data extraction apparatuses 100 in multiple stages. The data extraction apparatus 100 inputting data 1903 distributes it to two joiners 1910. One of the two joiners 1910 joins the data of a master file 1901 with the data 1903 and outputs the joined data to another data extraction apparatus 100 which then distributes the joining result to two totaling devices 1920. The two totaling devices 1920 output the totaling results to respectively different data extraction apparatuses 100 so that, receiving the inputs, each of the data extraction apparatuses 100 outputs the data distributedly to three files, respectively. These practices are the same for the other of the two joiners.

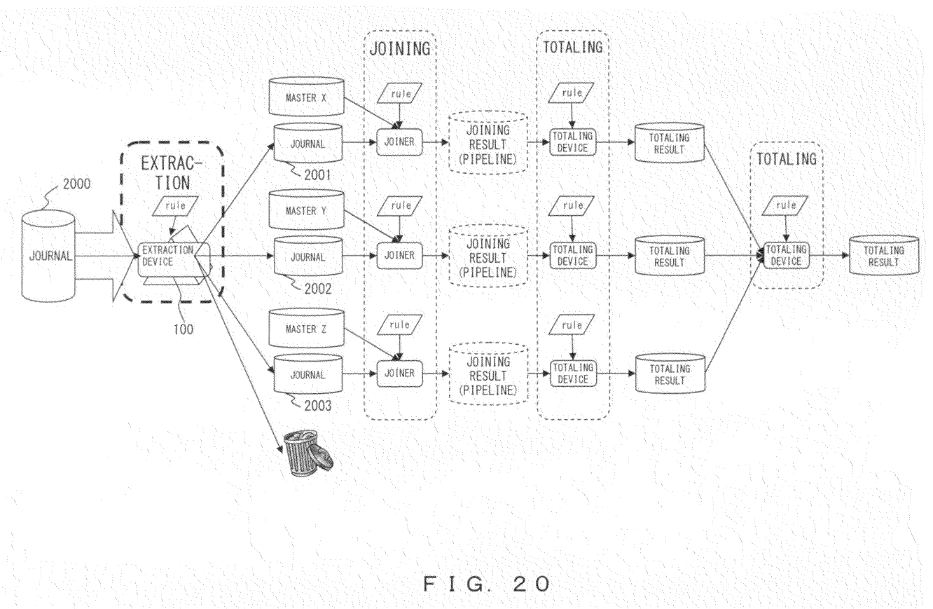

FIG. 20 exemplifies the case of using the data extraction apparatus 100 for distributing input data. The input data is the data of each record stored in a journal file 2000. The data extraction apparatus 100 is used for distributedly outputting the data satisfying an extraction condition to any one of the journal files 2001 through 2003. The reason for distributing as described above is to respond to the condition of joining with, for example, the masters X through Z. Distributing as such makes it possible to process the data in three systems parallelly and to accomplish the process at a higher speed.

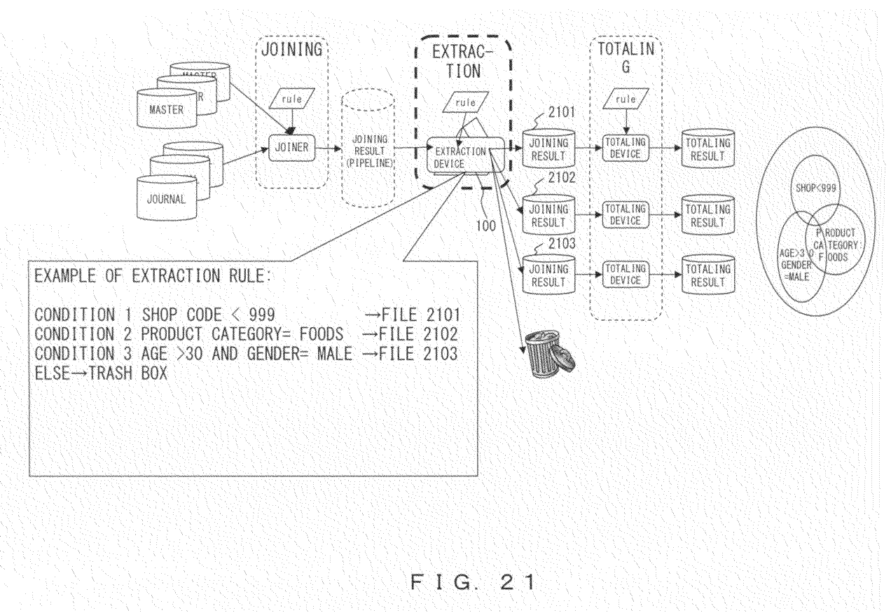

FIG. 21 exemplifies the case of using the data extraction apparatus 100 for distributing the data of a joining result. The joining result is a result of joining the data of a master with that of a journal. The data extraction apparatus 100 is used for outputting data satisfying any of the extraction conditions 1 through 3 to any of files 2101 through 2103 in accordance with the applicable extraction condition.

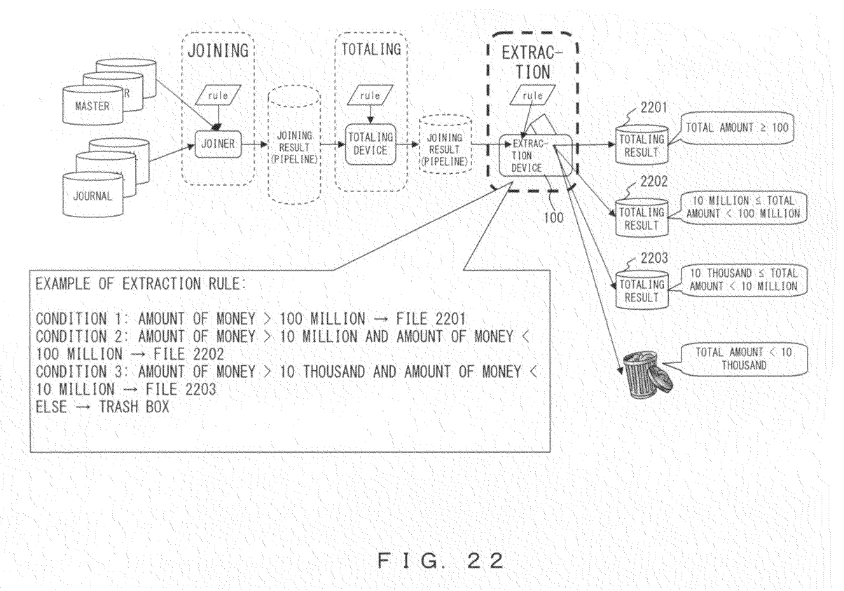

FIG. 22 exemplifies the case of using the data extraction apparatus 100 for distributing the data of a totaling result. The totaling result is a result of a totaling operation applied to the joining result of the data of a master and that of a journal. The data extraction apparatus 100 is used for outputting the data of a totaling result satisfying any of the extraction conditions 1 through 3 to any of files 2201 through 2203 in accordance with the applicable extraction condition.

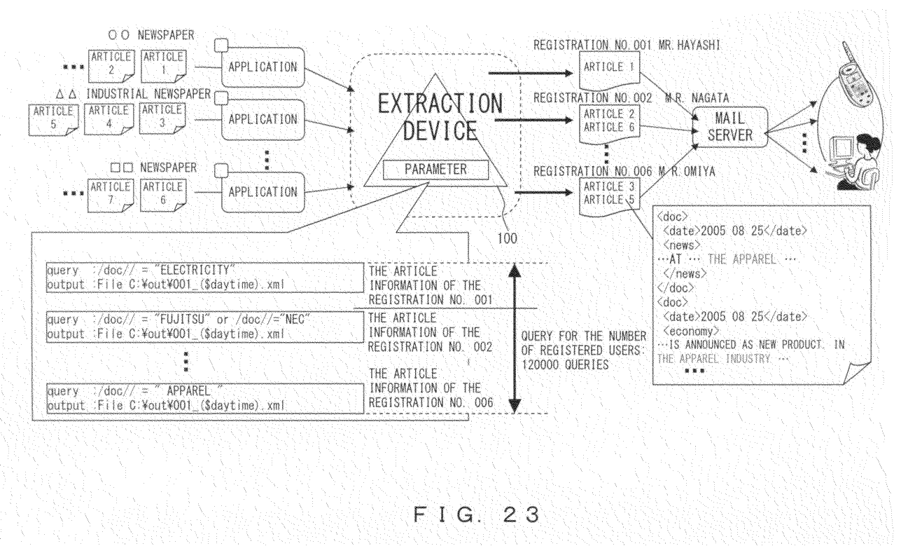

FIG. 23 exemplifies the case of using the data extraction apparatus 100 to provide a clipping service carried out by a newspaper publisher and the like. In this case, the data extraction apparatus 100 is provided, for each of the registered users, with the definition of an extraction condition which is satisfied by article data to be sent to the specific user. Pieces of article data are input into the data extraction apparatus 100 at any time and specific article data is output to a corresponding file in accordance with the extraction condition satisfied by the present article data. The article data output to the file is periodically distributed to the registered subscribers of a service. The add, delete, changes of request functions or the like of the registered subscribers of the service can be handled by the add, delete, changes of content functions of the extraction condition.

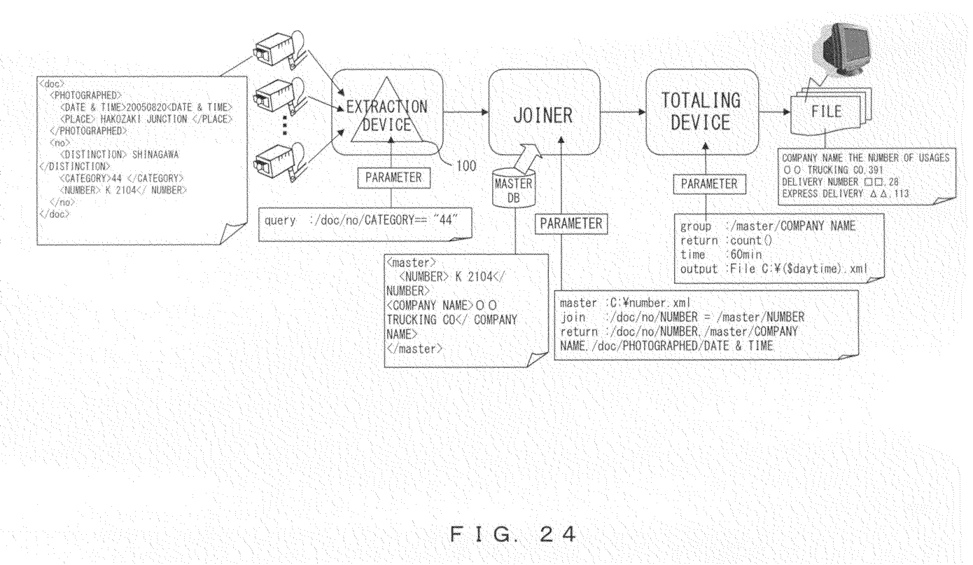

FIG. 24 exemplifies the case of using the data extraction apparatus 100 for a highway usage survey system. In this case, data is input from a highway monitor system to the data extraction apparatus 100 at any time. The data extraction apparatus 100 is provided with the definition of an extraction condition for extracting only the necessary data. With this, the data extraction apparatus 100 selects (i.e., filters) data in accordance with the extraction condition. The selected data is collated with the master data by using the joiner so as to expand it to further detail data. In the example shown, the company name “OO Trucking Co.” is added to the data of the number of the automobile, which is “k 2104”. The data collated with the master data is totaled by the totaling device for, for example, each company and then outputted.

Note that the present embodiment is configured to externally input data of which the output destination is distributed in accordance with the extraction condition; the aforementioned data may be a piece of data for generating data to be actually distributed or for a specific use. That is, it may be data such as coded compression data. Such data may be input by recording it in a recording medium MD.

What is claimed is:

1. A storage medium, accessed by a computer that can be used as a data extraction apparatus capable of extracting data satisfying a designated extraction condition from among obtainable data, and stores a program to realize a function, the function comprising:
a acquisition function for obtaining the data;
an input function for inputting the extraction condition;
an extraction function for extracting data for each of the extraction conditions by using one or more extraction conditions input by the inputting function; and
an output function for outputting the data extracted by the extraction function for each of the extraction conditions to an individually different output destination.

2. The storage medium according to claim 1, wherein
said extraction function identifies and extracts an extraction condition satisfied by said data from among input extraction conditions by performing one scan for the data.

3. The storage medium according to claim 1, wherein
said extraction function divides a conditional expression constituting said extraction condition into a plurality of partial conditional expressions and changes each extraction condition to a form expressed by a combination of the partial conditional expressions obtained by the division, thereby validating whether or not the data satisfies the partial conditional expression in units of partial conditional expressions.

4. The storage medium according to claim 3, wherein
said extracting function generates both an automaton at least being generated so as to transition to any reception state if a character string to be detected exists in said extraction condition and a logic table formed on the basis of the output of the automaton upon receiving the input of the extraction condition, and judges an output condition corresponding to the input of an extraction condition on the basis of the logic table.

5. The storage medium according to claim 4, wherein
said automaton comprises a tag Deterministic Finite state Automaton (DFA) for detecting said character string which is identical with said extraction condition, a layer collation DFA for detecting a layer designated by the extraction condition, and a key word DFA for detecting a key word within the extraction condition; and
said logic table comprises a first logic number table categorizing the extraction condition into each of said partial conditions, a search result judgment table categorized into each of the extraction conditions, and a second logic number table for correlating the first logic number table with the search result judgment table.

6. The storage medium according to claim 4, wherein
said automaton comprises a Comma Separated Values (CSV) analysis DFA for detecting a character string of said extraction condition input and a key word DFA for detecting a key word of an extraction condition input.

7. The storage medium according to claim 1, wherein
said input function is enabled to input an output condition related to the output destination of data correlated with said extraction condition together therewith, and
said output function outputs data satisfying an extraction condition correlated with the output condition in accordance therewith.

8. A storage medium, accessed by a computer that can be used as a data extraction apparatus capable of extracting data satisfying a designated extraction condition from among obtainable data, and stores a program to realize a function, the function comprising:
a acquisition function for obtaining the data;
an input function for inputting the extraction condition; and
an extraction function for dividing a conditional expression constituting the extraction condition input by the input function into a plurality of partial conditional expressions, converting the extraction condition into a form expressed by a combination of the partial conditional expressions obtained by the division, and validating whether or not the partial conditional expressions are satisfied in units of the partial conditional expression, thereby extracting data satisfying the extraction condition from among data obtained by the acquisition function.

9. The storage medium according to claim 8, wherein
said input function is capable of inputting one or more of said extraction conditions, wherein
the data extracted by the extraction function for each of the extraction conditions can be output to an individually different output destination.

10. A data extraction method for extracting data satisfying a designated extraction condition from among obtainable data, comprising:
enabling the input of a plurality of extraction conditions of which the target pieces of data are different;
extracting data for each of the extraction conditions when one or more of the extraction conditions are input; and
outputting the data obtained by the extraction to each respective output destination corresponding to the extraction condition satisfied by the data.
